(19) United States
(12) Patent Application Publication
(10) Pub. No.: US 2024/0327041 A1
(43) Pub. Date: Oct. 3, 2024

(54) LIQUID WATER REMOVAL FROM AN IONIC LIQUID MIXTURE OF A CONTAMINANT REMOVAL SYSTEM

(71) Applicant: Honeywell International Inc., Charlotte, NC (US)

(72) Inventors: Phoebe Henson, Glendale, AZ (US); Rebecca Kamire, Buffalo Grove, IL (US); Stephen Yates, South Barrington, IL (US)

(21) Appl. No.: 18/193,221

(22) Filed: Mar. 30, 2023

(51) Int. Cl. B64G 1/48; B01D 53/14

(52) U.S. Cl. CPC B64G 1/48; B01D 53/1418; B01D 53/1425; B01D 53/1475; B01D 2252/30; B01D 2257/504; B01D 2257/80; B01D 2259/40083; B01D 2259/4575

(57) ABSTRACT

A contaminant removal system includes a scrubber and an ionic liquid regeneration assembly. The scrubber is configured to absorb a contaminant from an air stream into an ionic liquid sorbent in an ionic liquid mixture. The ionic liquid regeneration assembly is configured to desorb the contaminant from the ionic liquid sorbent and remove liquid water from the ionic liquid mixture. The ionic liquid regeneration assembly may include a stripper for desorbing the contaminant and one or more reverse osmosis (RO) or nanofiltration (NF) membranes for removing the liquid water from the ionic liquid mixture.

### GOVERNMENT RIGHTS

This invention was made with Government support under Grant Contract Number 80MSFC18C0045 awarded by NASA Marshall Space Flight Center. The Government has certain rights in the invention.

### TECHNICAL FIELD

The present disclosure relates to systems and techniques for removing contaminants from an environment using contaminant removal systems.

### BACKGROUND

An environmental control system (ECS) may provide conditioned air to a passenger cabin or other environment. Some of this conditioned air may be treated to remove contaminants. ECS components that are used to remove contaminants may be large and heavy, increasing an overall weight of the ECS, and may consume large amounts of power heating, cooling, and pressurizing various fluid streams.

### SUMMARY

The disclosure describes systems and techniques for removing contaminants using an ionic liquid sorbent of an ionic liquid mixture and removing liquid water from the ionic liquid mixture to reduce a size and weight of an ECS. A contaminant removal system may include a scrubber that removes contaminants from an air stream, such as a cabin air stream of a spacecraft, through absorption using an ionic liquid sorbent in an ionic liquid mixture, and a stripper that desorbs the contaminants from the ionic liquid sorbent. A vacuum pump or other vacuum source downstream of the stripper drives desorption of the contaminants by generating a vacuum on the stripper.

In addition to absorbing the contaminants, the scrubber may absorb a portion of water from the air stream into the ionic liquid mixture. This increase of water in the ionic liquid mixture may increase an amount of load on the vacuum pump and reduce a capacity of the ionic liquid sorbent for absorbing the contaminants. However, removal of the water may be energy intensive, and may involve evaporating the water at the stripper and condensing and separating the water downstream of the stripper.

To increase a capacity of the ionic liquid sorbent and reduce an amount of energy to remove water from the ionic liquid mixture, the contaminant removal system includes an ionic liquid regeneration assembly configured to remove liquid water from the ionic liquid mixture. The ionic liquid regeneration assembly may include one or more reverse osmosis (RO) or nanofiltration (NF) membranes, such as positioned in an ionic liquid circuit between the scrubber and the stripper, part of the stripper, and/or positioned downstream of the stripper. Rather than remove gaseous water through evaporation, the RO/NF membranes may separate liquid water from the ionic liquid mixture to reduce a volume of water in the ionic liquid mixture. As a result, the ionic liquid circuit may use less power to heat and evaporate the water from the ionic liquid mixture, and/or the vacuum pump used to desorb and process the contaminants from the stripper may use less power and have a longer service life.

In some examples, the disclosure describes a contaminant removal system that includes a scrubber and an ionic liquid regeneration assembly. The scrubber is configured to absorb a contaminant from an air stream into an ionic liquid sorbent in an ionic liquid mixture. The ionic liquid regeneration assembly is configured to desorb the contaminant from the ionic liquid sorbent and remove liquid water from the ionic liquid mixture.

In some examples, the disclosure describes a method for removing a contaminant from an environment that includes absorbing, by a scrubber, a contaminant from an air stream into an ionic liquid sorbent in an ionic liquid mixture. The method further includes desorbing, by an ionic liquid regeneration assembly, the contaminant from the ionic liquid sorbent and removing, by the ionic liquid regeneration assembly, liquid water from the ionic liquid mixture.

In some examples, the disclosure describes a method for controlling a contaminant removal system that includes controlling, by control circuitry, a heater of an ionic liquid circuit to heat an ionic liquid mixture that includes an ionic liquid sorbent. The ionic liquid circuit includes a scrubber configured to absorb a contaminant from an air stream into the ionic liquid sorbent in the ionic liquid mixture and an ionic liquid regeneration assembly configured to desorb the contaminant from the ionic liquid sorbent and remove liquid water from the ionic liquid mixture. The method further includes controlling, by the control circuitry, a vacuum source of the ionic liquid regeneration assembly to desorb the contaminant from the ionic liquid sorbent using one or more reverse osmosis/nanofiltration (RO/NF) membranes. The method further includes controlling, by the control circuitry, a pressure source of the ionic liquid regeneration assembly to generate a pressure differential across the one or more RO/NF membranes.

### BRIEF DESCRIPTION OF THE FIGURES

The details of one or more examples are set forth in the accompanying drawings and the description below. Other features, objects, and advantages will be apparent from the description and drawings, and from the claims.

FIG. 1A is a block diagram illustrating an example contaminant removal system for removing contaminants using an ionic liquid sorbent.

FIG. 1B is a flow diagram illustrating an example method for removing a contaminant from an environment.

FIG. 2A is a schematic diagram illustrating an example contaminant removal system that includes a reverse osmosis (RO) or nanofiltration (NF) membrane unit between a scrubber and a stripper.

FIG. 2B is a schematic diagram illustrating an example contaminant removal system that includes two RO/NF membrane units in series.

FIG. 2C is a schematic diagram illustrating an example contaminant removal system that includes an RO/NF membrane unit between a scrubber and stripper and a dehumidifier upstream of the scrubber.

FIG. 3A is a schematic diagram illustrating an example contaminant removal system that includes an RO/NF membrane within a stripper.

FIG. 3B is a schematic diagram illustrating an example contaminant removal system that includes an RO/NF membrane within a stripper in series with an RO/NF membrane unit.

### DETAILED DESCRIPTION

A contaminant removal system includes a scrubber that removes contaminants from an air stream, such as a cabin air of a spacecraft, through absorption using an ionic liquid sorbent in an ionic liquid mixture and a stripper that desorbs the contaminants from the ionic liquid sorbent. To reduce a volume of the ionic liquid mixture, the contaminant removal system includes an ionic liquid regeneration assembly configured to remove water from the ionic liquid mixture using one or more reverse osmosis (RO) or nanofiltration (NF) membranes. The RO/NF membranes may be positioned in an ionic liquid circuit between the scrubber and the stripper, may be positioned downstream of the stripper, or may be part of the stripper. The RO/NF membranes may separate liquid water from the ionic liquid mixture to reduce a volume of water in the ionic liquid mixture. As a result, the ionic liquid circuit may use less power to heat and evaporate the water from the ionic liquid mixture and/or the vacuum pump used to desorb and process the contaminants from the stripper may use less power and have a longer service life.

Contaminant removal systems described herein may be utilized as part of an environmental control system (ECS), such as in spacecraft, aircraft, watercraft, and the like. In some examples, contaminant removal systems may be used in an ECS of a resource-limited environment, such as a passenger cabin of a spacecraft, in which carbon dioxide and water may be recycled to produce oxygen gas, water, methane, and a variety of other compounds used in life support systems. Such resource-limited environments may be particularly suited for a contaminant removal system that includes components that use low amounts of power and have extended service lives to reduce overall weight, power consumption, and maintenance load.

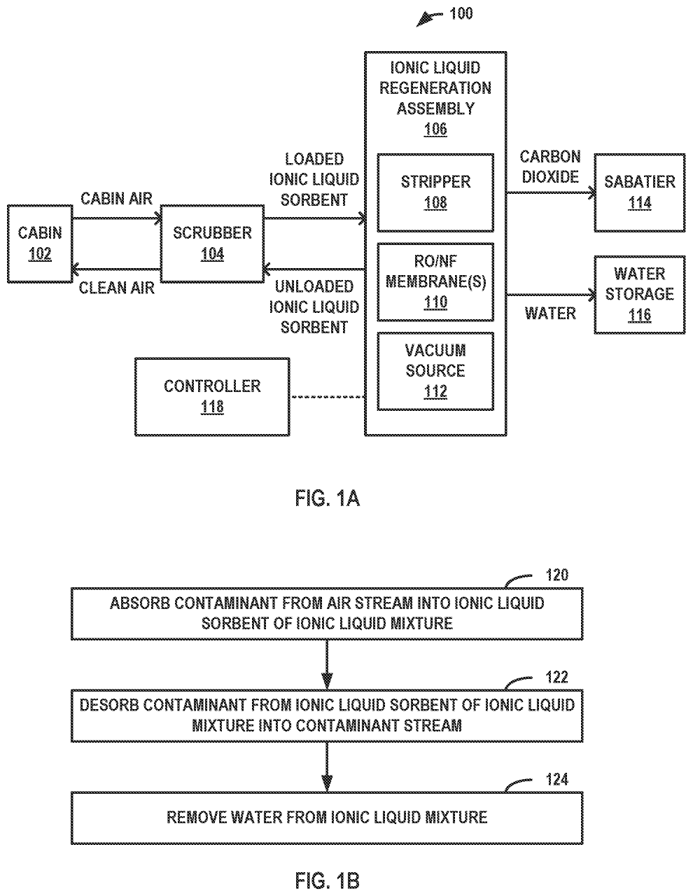

FIG. 1A is a block diagram illustrating an example contaminant removal system 100 for removing contaminants from an environment. Contaminant removal system 100 is configured to remove contaminants from a cabin 102. Cabin 102 may be a controlled environment, such as an aircraft cabin, spacecraft cabin, watercraft cabin, or the like, and contaminants removed from cabin 102 may include, but are not limited to, carbon dioxide, water, hydrocarbons, permanent gases, or the like. In the example of FIG. 1A, cabin 102 is a cabin of a closed-loop system, such as a spacecraft cabin or submarine cabin, in which components of a cabin air stream from cabin 102, such as carbon dioxide and water, may be removed within contaminant removal system 100, allowing a purified supply air stream to be generated and carbon dioxide and water to be recovered. However, in other examples, cabin 102 may be a cabin of an open-loop system, such as an aircraft cabin, in which components of a cabin air stream may be removed to generate a purified supply air stream with only partial or no subsequent recovery of the contaminants.

In examples in which the contaminant includes carbon dioxide, contaminant removal system 100 may include a Sabatier system 114 configured to convert the carbon dioxide to methane. Sabatier system 114 may be configured to react the contaminant with hydrogen to produce water and methane and either dry the methane for storage as fuel or send the methane to other reactors for further conversion. For example, while not shown in FIG. 1A, system 100 may include a methane pyrolysis system configured to convert methane to carbon and hydrogen, and subsequently return at least a portion of the hydrogen to Sabatier system 114 to produce more methane and water. Sabatier system 114 may be configured to send the water to an electrolysis system to produce hydrogen and oxygen, contributing to a more closed loop O₂/CO₂ cycle. In other examples, Sabatier system 114 may further pressurize the methane to above ambient pressure to form methane for rocket fuel.

System 100 is configured to remove the contaminants using an ionic liquid sorbent. Ionic liquid sorbents may be salts that are generally comprised of an anion and an organic cation. These salts may be liquid at their temperature of use, have effectively zero vapor pressure, be generally nontoxic, and/or have sufficient stability to resist deterioration. In some examples, liquid sorbents may contain relatively large organic cations and any of a variety of anions, which may be tailored to obtain desired characteristics, such as characteristics that improve absorption of the contaminant under operating conditions of system 100 and/or exclusion of the ionic liquid sorbent by a filtration membrane. Ionic liquid sorbents may be water soluble, hygroscopic (i.e., capable of absorbing moisture from the air), and/or capable of releasing water by evaporation, such as by elevating the temperature or reducing the water partial pressure. In system 100, the ionic liquid sorbent is dissolved in water to form an ionic liquid mixture. A mass fraction (or concentration) of ionic liquid sorbent in the ionic liquid mixture may be sufficiently high to remove contaminants and sufficiently low that the ionic liquid sorbent remains in solution through operating ranges (e.g., temperature range, pH range) and/or maintains a low viscosity.

Contaminant removal system 100 includes a scrubber 104. Scrubber 104 is configured to absorb one or more contaminants from a cabin air stream into the ionic liquid sorbent and discharge a clean air stream to cabin 102. Scrubber 104 is configured to receive unloaded ionic liquid sorbent having a relatively low concentration of contaminants, contact the unloaded ionic liquid sorbent with cabin air through one or more separation membranes to absorb the contaminants into the ionic liquid sorbent, and discharge loaded ionic liquid sorbent that includes a higher concentration of contaminants.

Contaminant removal system 100 includes an ionic liquid regeneration assembly 106. Ionic liquid regeneration assembly 106 includes a stripper 108 configured to desorb one or more contaminants from the loaded ionic liquid sorbent and discharge the contaminants from stripper 108, such as to a Sabatier system 114. Stripper 108 is configured to receive the loaded ionic liquid sorbent from scrubber 104, contact the loaded ionic liquid sorbent with a sweep gas stream or other low pressure volume through one or more separation membranes to desorb the contaminant from the ionic liquid sorbent, and discharge unloaded liquid sorbent that includes a lower concentration of the contaminant. To desorb the contaminant from the ionic liquid sorbent, the gas phase side of stripper 108 may be at a vacuum. Ionic liquid regeneration assembly 106 includes a vacuum source 112 configured to generate the vacuum to desorb the contaminant from the ionic liquid sorbent and pressurize the contaminant, such as for further storage or processing. A variety of vacuum sources may be used for vacuum source 112 including, but not limited to, a compressor, a vacuum pump, or the like.

As mentioned above, ionic liquid sorbent, along with various other liquids and/or compounds, may be present in water as an ionic liquid mixture. During absorption and/or desorption of the contaminant, water may be absorbed into the ionic liquid sorbent, thereby increasing a concentration of water and overall volume of the ionic liquid mixture. For example, in addition to absorbing carbon dioxide, scrubber 104 may also absorb water from a cabin air stream into the ionic liquid sorbent. A rate of absorption of the contaminant at the scrubber and a rate of desorption of the contaminant at the stripper may be related to a volume fraction of ionic liquid sorbent in the ionic liquid mixture, such that an increase in the volume fraction of water may reduce a volume fraction of the ionic liquid sorbent. An amount of power used by various components within system 100 may correspond to the volume fraction of water and the overall volume of the ionic liquid mixture, such that an increase in the volume of the ionic liquid mixture due to the absorption of water may increase an amount of power used by system 100. For example, vacuum source 112 may pressurize both a desired contaminant, such as carbon dioxide, as well as water desorbed from stripper 108. As an amount of water in the ionic liquid mixture increases, an amount of water desorbed by stripper 108 may also increase, resulting in vacuum source 112 consuming more power.

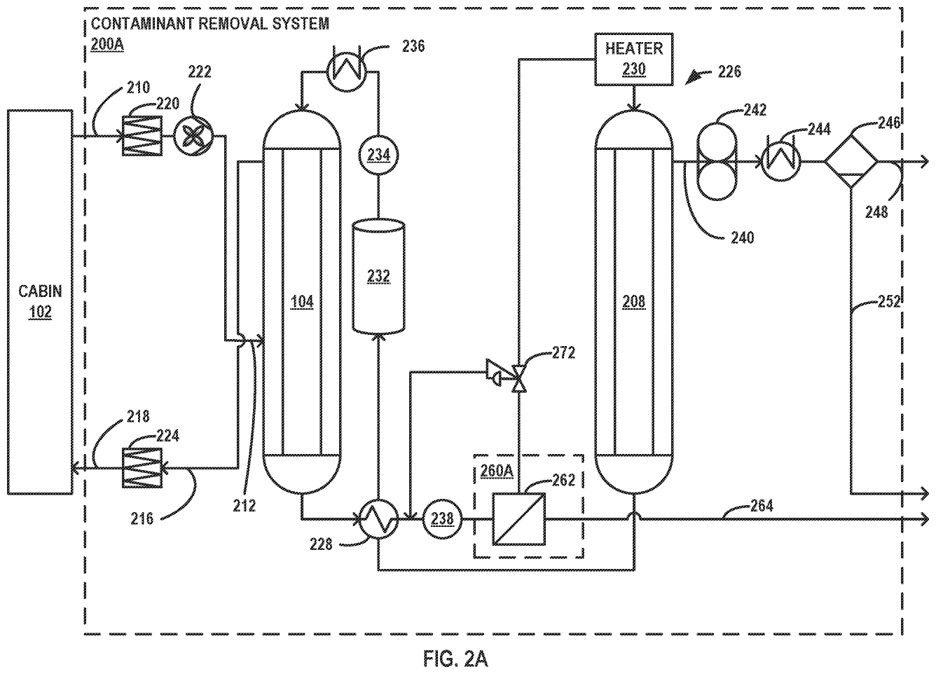

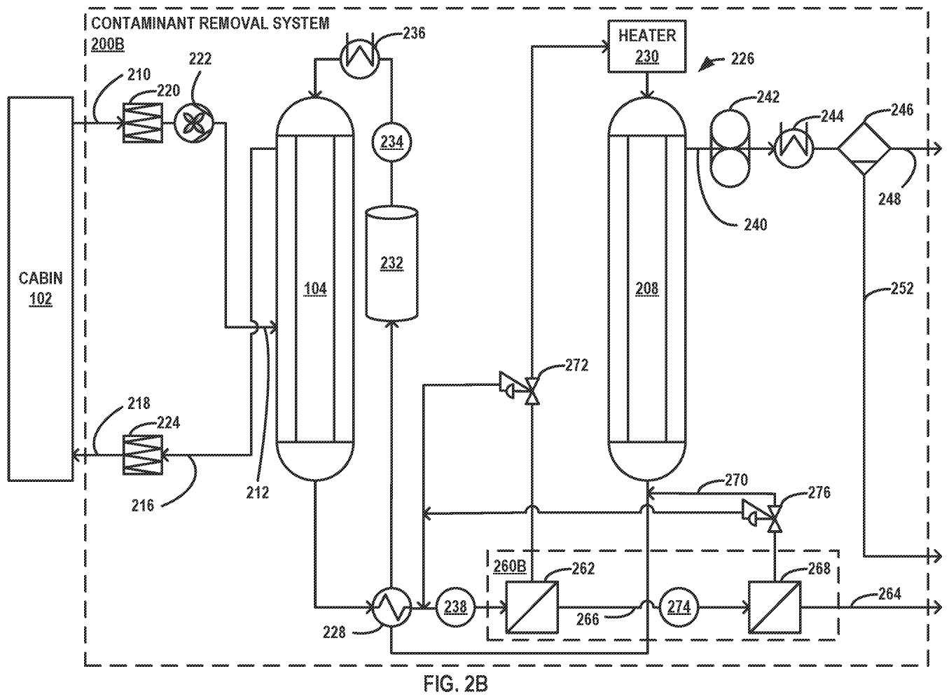

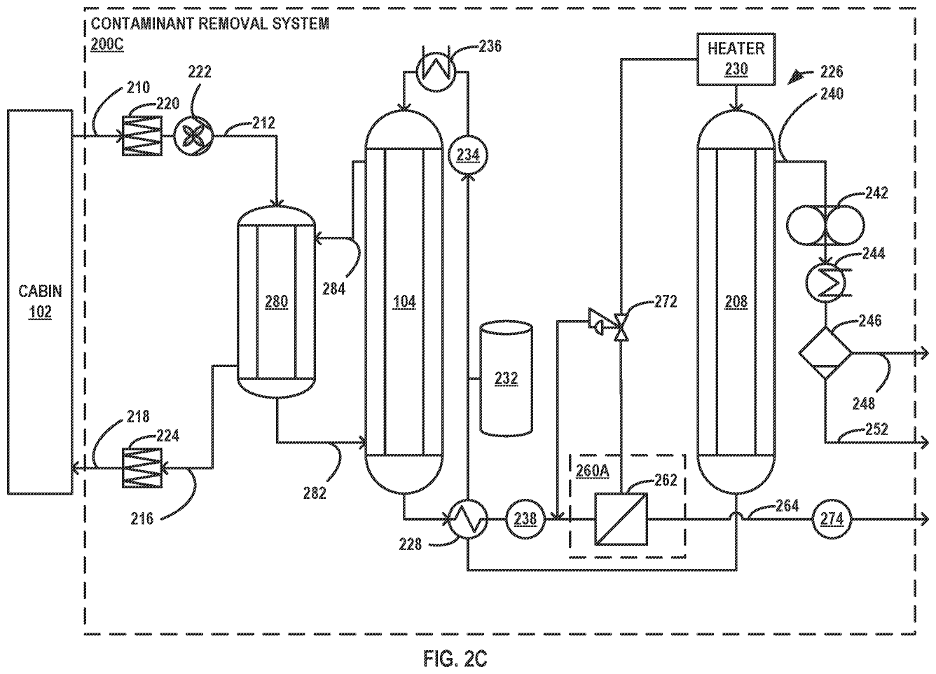

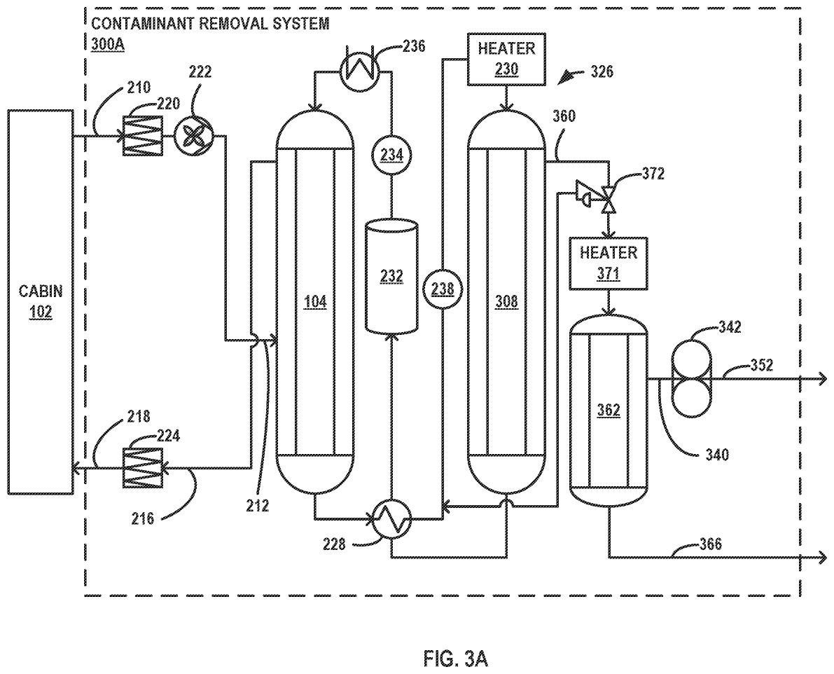

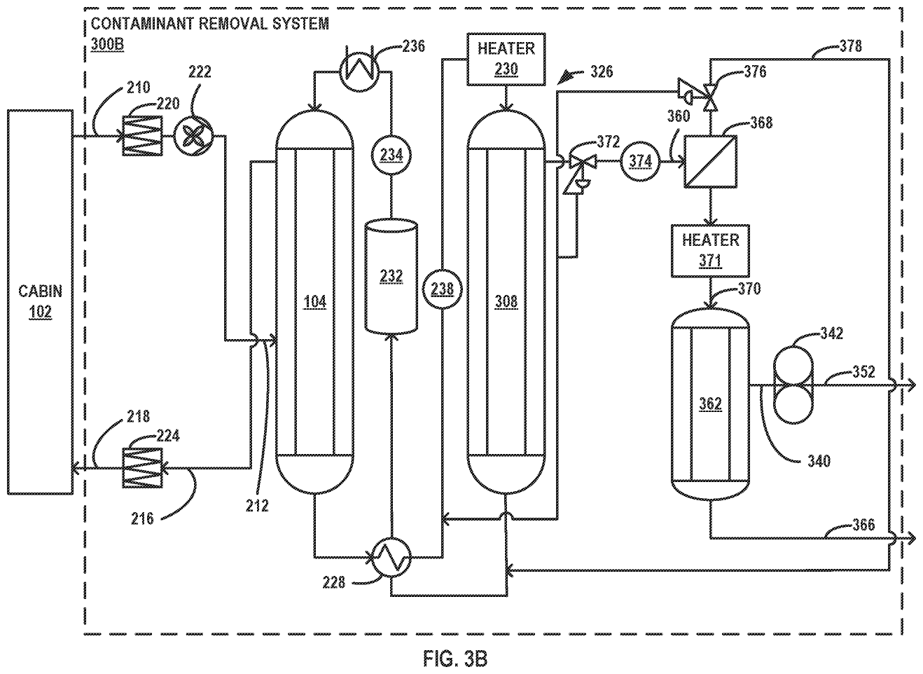

To reduce an amount of power used by system 100 to remove contaminants, ionic liquid regeneration assembly 106 is configured to control an amount of water in the ionic liquid mixture by removing liquid water from the ionic liquid mixture. As will be further described in FIGS. 2A-3B below, liquid water may be removed from the ionic liquid mixture at various points in an ionic liquid circuit, such as between scrubber 104 and stripper 108 during circulation, at stripper 108 during desorption, or downstream of stripper 108 prior to contaminant processing, to reduce an amount of water removed by stripper 108 through evaporation and/or recirculated to scrubber 104. The removed water may be discharged to a water storage system 116, evaporated and used as a sweep gas stream for stripper 108, or returned to the ionic liquid mixture, among other uses.

Ionic liquid regeneration assembly 106 may be configured to remove the water from the ionic liquid mixture using one or more reverse osmosis or nanofiltration (RO/NF) membranes 110. RO/NF membranes 110 may be configured to reduce or exclude migration of even relatively small molecular species, such as the ionic liquid sorbent, and permit migration of water, such that water and any desorbed contaminants may pass through RO/NF membrane 110 at a higher rate than the ionic liquid sorbent. As a result, a retentate stream from RO/NF membrane 110 may have a lower volume of water than the inlet stream. RO/NF membranes 110 may be configured according to various parameters that increase selectively for water over dissolved salt ions, such as the ionic liquid sorbent, including, but not limited to, parameters related to a chemical composition of RO/NF membrane 110, parameters related to a layer of RO/NF membrane 110, parameters related to a coating of RO/NF membrane 110, or the like. RO/NF membrane 110 includes one or more RO membranes, one or more NF membranes, or any combination of RO or NF membranes.

RO membranes may include a dense, semi-permeable polymeric film that is permeable to water and selectively permeable to molecular species based on a charge and size of the particular molecular species. For example, a molecular species that has a high charge (e.g., monovalent or polyvalent) and/or high molecular weight (e.g., greater than 200) or size (e.g., greater than 0.001 micrometers) may be excluded by an RO membrane. An RO membrane may include various characteristics, such as surface charge, that affect the permeability of a particular molecular species. In response to a pressure differential exerted across the RO membrane, the RO membrane may permit migration of water and exclude migration of salts, such as the ionic liquid sorbent. The pressure differential across the RO membrane may be relatively high to overcome an osmotic pressure of the water, such as between about 1.3 MPa and about 6.9 MPa.

NF membranes may include a porous, semi-permeable polymeric film that is permeable to water and selectively permeable to molecular species based on charge, size, and/or surface tension of the particular molecular species. For example, a molecular species that has a high charge, a high molecular weight (e.g., greater than 20,000) or size (e.g., greater than 0.01 micrometers), and/or a high surface tension or contact angle may be excluded by an NF membrane. An NF membrane may include various characteristics, such as surface charge, pore size, and porosity, that affect the permeability of a particular molecular species. For example, an NF membrane may have an average pore size between about 1 nanometer and about 10 nanometers and an average porosity between about 0.3 to about 0.7. In response to a pressure differential exerted across the RO membrane, the RO membrane may permit migration of water and exclude migration of salts, such as the ionic liquid sorbent. The pressure differential across the RO membrane may be relatively moderate, such as between about 0.3 MPa and about 1.6 MPa.

Ionic liquid regeneration assembly 106 may be configured to return at least a portion of ionic liquid sorbent removed with the water to the ionic liquid mixture. For example, ionic liquid regeneration assembly 106 may include two or more RO/NF membranes 110 arranged in series, and at least one of the two or more RO/NF membranes 110 may be configured to return at least a portion of ionic liquid sorbent removed with the water to the ionic liquid mixture.

Contaminant removal system 100 may include a process control system that includes a controller 118 and one or more sensor sets (not shown). Controller 118 may be configured to receive measurements from the one or more sensor sets and/or components of contaminant removal system 100 and/or send control signals to components of contaminant removal system 100. Controller 118 may be communicatively coupled to and configured to receive measurement signals from the one or more sensor sets, and other process control components (not shown) of contaminant removal system 100, such as: control valves for various streams; pumps; heaters; heat exchangers; compressors; and the like. The sensor sets may include instrumentation configured to detect any of a pressure, temperature, flow rate, and/or contaminant concentration (e.g., carbon dioxide concentration or water concentration) of a liquid or gas stream of contaminant removal system 100. Controller 118 may be configured to use the detected conditions to control operation of contaminant removal system 100 to function as described in the application.

Controller 118 may include any of a wide range of devices, including control circuitry, processors (e.g., one or more microprocessors, one or more application specific integrated circuits (ASICs), one or more field programmable gate arrays (FPGAs), or the like), processing circuitry, one or more servers, one or more desktop computers, one or more notebook (i.e., laptop) computers, one or more cloud computing clusters, or the like.

In some examples, controller 118 is configured to control a contaminant concentration within the environment of cabin 102. For example, controller 118 may be configured to receive a contaminant concentration measurement for a contaminant, such as from cabin air sensor set or a contaminant concentration sensor in cabin 102. Controller 118 may be configured to determine whether the contaminant concentration measurement exceeds a contaminant concentration setpoint. For example, the contaminant concentration setpoint may be a target concentration of the supply air stream for maintaining cabin 102 below a threshold contaminant concentration. Controller 118 may be configured to send, in response to the contaminant concentration measurement exceeding the contaminant concentration setpoint, a control signal to decrease a concentration of the contaminant in the supply air stream. For example, controller 118 may send a control signal to control a flow rate of the ionic liquid mixture; a flow rate, humidity, and/or temperature of a sweep gas stream into stripper 108; a temperature of the ionic liquid mixture at scrubber 104 or stripper 208; a flow rate of the cabin air stream; or any other variable that may control a rate of removal of contaminants from the cabin air stream.

FIG. 1B is a flow diagram illustrating an example method for removing a contaminant from an environment, described with respect to system 100 of FIG. 1A. To remove contaminants from cabin 102, the method includes absorbing, by scrubber 104, a contaminant from an air stream into an ionic liquid sorbent in an ionic liquid mixture (120). For example, controller 118 may detect that the cabin air stream has a concentration of one or more contaminants that is above a threshold and, in response, control components of a cabin air circuit to control a flow rate of the cabin air stream and components of an ionic liquid circuit to control a flow rate and temperature of the ionic liquid mixture. As a result, a clean air stream has a lower concentration of the contaminant than the cabin air stream. For example, the clean air stream may have a concentration of a contaminant that is about 25% to about 99% less than a concentration of the contaminant in the cabin air stream.

To recover the contaminant from the ionic liquid sorbent, the method includes desorbing, by ionic liquid regeneration assembly 106, the contaminant from the ionic liquid sorbent (122). For example, controller 118 may control components of an ionic liquid circuit to control a flow rate of ionic liquid sorbent between scrubber 104 and stripper 108 and control components for processing a contaminant stream, such as vacuum source 112, to create a pressure differential across stripper 108 to cause stripper 108 to desorb the contaminant from the ionic liquid sorbent.

To reduce a volume of water processed as part of the ionic liquid mixture and/or the contaminant stream, the method includes removing, by ionic liquid regeneration assembly 106, water from the ionic liquid mixture (124). Controller 118 may control one or more components of an ionic liquid circuit to control various parameters, such as a flow rate through RO/NF membrane 110, temperature of RO/NF membrane 110, or pressure differential across RO/NF membrane 110, to remove water from the ionic liquid mixture, either in-stream or as part of stripper 108, to reduce an amount of water in the ionic liquid mixture. For example, controller 118 may control a pressure source of the ionic liquid regeneration assembly to generate a pressure differential across RO/NF membrane 110.

In some examples, ionic liquid regeneration systems may remove water from the ionic liquid mixture as part of an ionic liquid circuit between a scrubber and a stripper. FIG. 2A is a schematic diagram illustrating an example contaminant removal system that includes a filtration assembly 260 in an ionic liquid circuit 226.

Contaminant removal system 200A includes a cabin air circuit configured to circulate cabin air between cabin 102 and scrubber 104. In the example of FIG. 2A, cabin air stream 210 includes a filter 220 configured to remove particulates from cabin air stream 210 prior to entry into scrubber 104 and a compressor 222 configured to draw cabin air into scrubber 104, while a supply air stream 218 includes a filter 224 configured to remove any leaked ionic liquid sorbent and/or further filter clean air from supply air stream 218 prior to entry into cabin 102.

Contaminant removal system 200A includes an ionic liquid circuit 226 configured to circulate ionic liquid sorbent between scrubber 104 and stripper 208. For example, a pump 234 may pump unloaded ionic liquid sorbent from an ionic liquid storage 232 and/or stripper 208 into scrubber 104. Unloaded ionic liquid sorbent may include unused ionic liquid sorbent free of contaminants or regenerated ionic liquid sorbent having a lower concentration of contaminants than the loaded ionic liquid sorbent. In some examples, the unloaded ionic liquid sorbent may be cooled by a cooler 236 prior to entry into scrubber 104. In some examples, the loaded ionic liquid sorbent may be pumped by a pump 238 and/or preheated by a heat exchanger 228 and/or heater 230 prior to entry into stripper 208.

In the example of FIG. 2A, the ionic liquid regeneration assembly includes a filtration assembly 260A in ionic liquid circuit 226 between scrubber 104 and stripper 208. Filtration assembly 260A is configured to control a composition of the ionic liquid mixture by removing water from the ionic liquid mixture. In the example of FIG. 2A, filtration assembly 260A is configured to receive the ionic liquid mixture from scrubber 104, remove water from the ionic liquid mixture, and discharge the ionic liquid mixture to stripper 208. As a result of the water removal, the discharged ionic liquid mixture may have a higher concentration of the ionic liquid sorbent and a lower overall volume of the ionic liquid mixture.

Filtration assembly 260A includes one or more RO/NF membrane units 262. In the example of FIG. 2A, filtration assembly 260A includes a single RO/NF membrane unit 262; however, filtration assembly 260A may include any number of RO/NF membranes units arranged in parallel or series. RO/NF membrane unit 262 is configured to receive the ionic liquid mixture in ionic liquid circuit 226, discharge a portion of the ionic liquid mixture to ionic liquid circuit 226, and discharge water removed from the ionic liquid mixture as a water stream 264.

As explained in FIG. 1A with respect to RO/NF membrane 110, RO/NF membrane unit 262 includes one or more RO/NF membranes 110 (not shown) configured to remove water from the ionic liquid mixture by restricting flow of ionic liquid sorbent and permitting flow of water. RO/NF membranes 110 may have a greater affinity to pass through water than the larger charged ionic liquid sorbent ions, such that water and any desorbed contaminants may pass through RO/NF membrane unit 262 at a higher rate than the ionic liquid sorbent. Each RO/NF membrane unit 262 may include a feed inlet for a feed stream, one or more RO/NF membranes 110, a retentate outlet for a diluent stream that does not pass through the one or more RO/NF membranes, and a permeate outlet for a permeate stream that passes through the one or more RO/NF membranes. RO/NF membrane unit 262 may be configured to receive the ionic liquid mixture as a feed stream at the feed inlet, discharge a diluent stream that includes the ionic liquid mixture having a lower volume of water than the feed stream, and discharge a permeate stream that includes the removed volume of water (e.g., water stream 264).

Removing water from the ionic liquid mixture may reduce an amount of power consumed by components of ionic liquid circuit 226. For example, a rate or capacity of absorption of contaminants into the ionic liquid sorbent and desorption of the contaminants from the ionic liquid sorbent may be dependent on a temperature of the ionic liquid sorbent in scrubber 104 and stripper 208, respectively, and a concentration of ionic liquid sorbent in the ionic liquid mixture. Components of ionic liquid circuit 226, such as heat exchanger 228, heater 230, pump 234, cooler 236, and pump 238, may use an amount of power at least partly based on a volume of the ionic liquid mixture in ionic liquid circuit 226. By removing water from the ionic liquid mixture, ionic liquid circuit 226 may use less power to process the ionic liquid mixture, even when accounting for a higher pressure differential required to remove water at higher ionic liquid concentrations.

Removing water from the ionic liquid mixture may reduce an amount of power consumed by components downstream of the ionic liquid circuit that process the contaminants. For example, in addition to desorbing contaminants, stripper 208 may also remove a portion of water from the ionic liquid mixture. A rate of removal of water from the ionic liquid mixture in stripper 208 may be dependent on a composition of water in the ionic liquid mixture. By reducing an amount of water from the ionic liquid mixture, a contaminant stream discharged from stripper 208 may include a lower amount of water to be pressurized, condensed, and removed downstream of stripper 208.

Pump 238, filtration assembly 260A, and pressure regulator 272 may be configured as a unit. For example, pump 238 may maintain a sufficiently high pressure on a feed side of RO/NF membrane unit 262 to provide sufficient flow through RO/NF membrane unit 262, while pressure regulator 272 may maintain a sufficiently low pressure downstream of RO/NF membrane unit 262 to provide sufficiently low pressure at stripper 208. While shown as being positioned between heat exchanger 228 and heater 230, pump 238, filtration assembly 260A, and pressure regulator 272 may be positioned at other points in ionic liquid circuit 226. A position of filtration assembly 260A may be selected based on performance of RO/NF membranes 110 at different temperatures. For example, pump 238, filtration assembly 260A, and pressure regulator 272 may be positioned anywhere in liquid sorbent circuit 226 from a coldest point (e.g., between cooler 236 and scrubber 104) and a hottest point (e.g., between heater 230 and stripper 208).

A position of filtration assembly 260A may be selected based on performance of RO/NF membranes 110 at different pressure differentials. As mentioned above, water may permeate through RO/NF membranes 110 of filtration assembly 260A in response to a pressure differential (or transmembrane pressure) across RO/NF membranes 110. In some examples, filtration assembly 260A may be positioned downstream of pump 238, such that pressure from pump 238 may assist in pushing water through filtration assembly 260A. The resulting pressure drop may reduce a pressure of the ionic liquid mixture at stripper 208, which may be beneficial for extending the service time of stripper 208. In some examples, liquid sorbent circuit 226 may further include a pressure regulator 272, such as a pressure regulator valve, configured to maintain a pressure of the ionic liquid mixture received by stripper 208 below a threshold. For example, an RO membrane may require a relatively high pressure differential to overcome an osmotic pressure and operate efficiently. However, the pressure of the ionic liquid mixture discharged by filtration assembly 260A may still be above a desired maximum pressure for stripper 208. Pressure regulator 272 may be configured to reduce the pressure of the ionic liquid mixture upstream of stripper 208.

Scrubber 104 is configured to absorb the contaminant from cabin air stream 212 into an ionic liquid sorbent and discharge a clean air stream 216 to cabin 102. On a gas phase side, scrubber 104 is configured to receive cabin air from cabin air stream 212 that includes contaminant species from cabin 102, such as carbon dioxide, water, hydrocarbon volatiles, permanent gases, and other gaseous substances. Scrubber 104 is configured to absorb one or more contaminant species in the cabin air into an ionic liquid sorbent. Scrubber 104 includes one or more separation membranes, each configured to flow (e.g., provide or direct flow of) cabin air from cabin air stream 212 on a gas phase side (e.g., a tube side) of the respective membrane and flow an ionic liquid sorbent on a liquid phase side (e.g., a shell side) of the membrane. Contaminants may pass through the membrane due to a concentration gradient between the cabin air and the ionic liquid sorbent and become absorbed by the ionic liquid sorbent, while the ionic liquid sorbent may not substantially flow through the membrane. As a result, clean air from clean air stream 216 discharged from scrubber 104 may have a lower concentration of contaminants than cabin air from cabin air stream 212 received by scrubber 104. Scrubber 104 is configured to discharge a clean air stream 216 to cabin 102.

On a liquid phase side, scrubber 104 is configured to receive unloaded ionic liquid sorbent, such as from ionic liquid storage 232. The unloaded ionic liquid sorbent may flow through scrubber 104 and absorb contaminants from cabin air through the membrane(s) of scrubber 104. As a result, the loaded ionic liquid sorbent discharged from scrubber 104 may have a higher concentration of contaminants than the unloaded ionic liquid sorbent received by scrubber 104. Scrubber 104 may discharge the loaded ionic liquid sorbent containing the contaminants to stripper 208.

Contaminant removal system 100 includes stripper 208 downstream of scrubber 104. Stripper 208 is configured to desorb the contaminant from the ionic liquid sorbent into a contaminant stream 240. On a liquid phase side, stripper 208 is configured to receive loaded ionic liquid sorbent from scrubber 104 and desorb one or more contaminants from the loaded ionic liquid sorbent. Stripper 208 includes one or more membranes, each configured to flow the loaded ionic liquid sorbent on one side (e.g., a shell side) of the membrane and contaminated air to a contaminant stream 240 on an opposite side (e.g., a tube side) of the membrane. Contaminants may flow across fibers of the membrane due to a concentration gradient, while the ionic liquid sorbent may not substantially flow across the fibers of the membrane. As a result, unloaded ionic liquid sorbent discharged from stripper 208 may have a lower concentration of contaminants than the loaded ionic liquid sorbent received by stripper 208. On a gas phase side, stripper 208 is configured to discharge the contaminant in a contaminant stream 240. Contaminant stream 240 may be continuously removed from stripper 208 to assist migration of the contaminants from the loaded ionic liquid sorbent into contaminant stream 240.

Scrubber 104 and/or stripper 208 may include one or more membrane separators configured to flow air on a first side and flow ionic liquid sorbent on a second, opposite side. For example, a membrane separator may include a plurality of parallel membrane contactors. In some examples, a membrane contactor may include a cylindrical module filled with parallel or woven hollow porous fibers. For example, dimensions of these hollow fibers could be less than about 3 mm, and the pore dimension could be less than about 2 microns. The high surface area of the hollow fiber membrane contactors enables a high mass transfer of contaminant gasses, such as carbon dioxide and water, into the ionic liquid sorbent using a relatively small system volume and weight. The material of the hollow fibers can be selected such that the ionic liquid sorbent does not wet the pores, and the trans-membrane pressure is kept sufficiently low to prevent pore penetration. As a result, the membrane contactor may ensure that the ionic liquid sorbent and gas stream do not need further separation, such that contaminant removal system 200A may act in a gravity-independent way without the use of moving parts. Fiber materials may include, but are not limited to, hydrophobic materials such as polypropylene, polyvinylidene fluoride, polysulfone, polyimide, polytetrafluoroethylene (PTFE), and the like. In some examples, a coating may be applied to reduce liquid flow through the pores. Coatings that may be used include, but are not limited to, PTFE, a crosslinked siloxane, perfluorinated polymers, functionalized nanoparticles, and the like to prevent liquid flow through the pores. While described in FIG. 2A as flowing through a “tube” side, ionic liquid sorbent flow can be either on the “tube” side or the “shell” side, while air is flowed on the opposite side.

In the example of FIG. 2A, contaminant removal system may include one or more systems or components configured to further process contaminant stream 240. In some examples, contaminant removal system 200A includes a compressor 242, condenser 244, and water separator 246 configured to compress contaminant stream 240 and remove water from the compressed contaminant stream 240. For example, for carbon dioxide removed from contaminant removal system 200A to be stored or recycled, compressor 242, condenser 244, and water separator 246 may compress contaminant stream 240 to a high pressure and remove nearly all water from contaminant stream 240. In a life support application, a large amount of water may be present in cabin air stream 210. For example, the concentration of water in cabin air stream 210 may be much higher than that of carbon dioxide. Sabatier system 114 may require a water concentration of less than 2% to react hydrogen gas with carbon dioxide.

Compressor 242 is configured to compress contaminant stream 240. A variety of compressors may be used for compressor 242 including, but not limited to, centrifugal compressors, positive displacement compressors, and the like. Condenser 244 may be configured to cool contaminant stream 240 and condense water from contaminant stream 240. For example, condenser 244 may be coupled to a refrigeration system or other cooling system that circulates a cooling medium to cool contaminant stream 240. A variety of condensers may be used for condenser 244 including, but not limited to, shell and tube heat exchangers, plate-fin, surface coolers, heat pipes, thermoelectric devices, cooling jackets, and the like. Water separator 246 may be configured to remove water from contaminant stream 240, discharge a dehumidified contaminant stream 248 to Sabatier system 114, and discharge contaminant water stream 252 to water storage 116. A variety of water separators may be used including, but not limited to, static phase separators, capillary phase separator, membrane phase separators, centrifugal/rotary separators, and the like.

Controller 118 may be communicatively coupled to and configured to receive measurement signals from the one or more sensor sets, and other process control components (not shown) of contaminant removal system 200A, such as: control valves for cabin air stream 210, clean air stream 216, supply air stream 218, contaminant stream 240, and inlets/outlets to heat exchanger 228, heater 230, ionic liquid storage 232, and cooler 236; pump 234; pump 238; blower 222, compressor 242 (e.g., pumping speed); and the like.

In some examples, an ionic liquid regeneration system may be further configured to recover ionic liquid sorbent from the removed water. FIG. 2B is a schematic diagram illustrating an example contaminant removal system that includes two RO/NF membranes in series. For example, while RO/NF membranes may have a high affinity for water removal (e.g., a permeate composition of >95% by weight of water), the permeate stream may still include a small amount of ionic liquid sorbent. To further recover the ionic liquid sorbent, filtration assembly 260B includes at least two RO/NF membrane units fluidically coupled in series. In the example of FIG. 2B, filtration assembly 260B includes two RO/NF membrane units 262, 268; however, filtration assembly 260B may include any multiple number of RO/NF membrane units in series.

RO/NF membrane unit 262 may be configured to discharge an intermediate permeate stream 266 to RO/NF membrane unit 268. As mentioned above, intermediate permeate stream 266 may include a small amount of ionic liquid sorbent. RO/NF membrane unit 268 may be configured to receive permeate stream 266 as a feed stream, discharge a retentate stream as a return stream 270 that includes the ionic liquid sorbent and a lower volume of water than permeate stream 266, and discharge a permeate stream that includes the removed volume of water (e.g., water stream 264). RO/NF membrane unit 268 may discharge return stream 270 to ionic liquid circuit 226, such as downstream of scrubber 104. Permeate stream 266 may include a pump 274 or other pressure source configured to create a pressure differential across RO/NF membrane unit 268 and a pressure regulator 276 configured to maintain a pressure of return stream 270 below a threshold, such as described with respect to pump 238 and pressure regulator 272, respectively.

Returning ionic liquid sorbent to ionic liquid circuit 226 may reduce a size of components of ionic liquid circuit 226. For example, a size of ionic liquid storage 232 and amount of ionic liquid mixture stored in ionic liquid storage 232 may correspond to an anticipated loss rate of ionic liquid sorbent from ionic liquid circuit 226. By reducing the loss rate of ionic liquid through filtration assembly 260B, the size of ionic liquid storage 232, the amount of ionic liquid mixture stored in ionic liquid storage 232, and/or the amount of ionic liquid mixture in removed water may be reduced.

Separating water removal into multiple RO/NF membrane units 262, 268 may increase an efficiency of filtration assembly 260B by permitting operation of RO/NF membrane units 262, 268 at lower pressures. For example, a first amount of water may be removed from membrane unit 262 in a first stage, and a second amount of water may be removed from membrane unit 268 at a second stage. A pressure differential at each stage created by each of pumps 238 and 274 may be lower than an overall pressure differential across filtration assembly 260B, such that RO/NF membranes 110 may be exposed to lower pressures and/or less robust RO/NF membranes 110 may be used.

In some examples, ionic liquid removal systems described herein may further include one or more components configured to control an amount of water vapor upstream of scrubber 204. FIG. 2C is a schematic diagram illustrating an example contaminant removal system that includes an RO/NF membrane unit between a scrubber and stripper and a dehumidifier 280 upstream of the scrubber. Dehumidifier 280 may be configured to recover humidity from cabin air stream 212 for use in clean air stream 216. On one side, dehumidifier 280 may be configured to receive cabin air from cabin air stream 212 as a feed gas and discharge cabin air having a lower humidity as a dehumidified stream 282. On an opposite side, dehumidifier 280 may be configured to receive decontaminated air 284 from scrubber 104 as a sweep gas and discharge clean air stream 310 having a higher humidity. As a result, water may be removed from cabin air stream 212 upstream of scrubber 104, thereby reducing an amount of liquid water removed by the ionic liquid regeneration system.

In addition to dehumidifier 280, FIG. 2C illustrates various alternative arrangements of components within system 100. As one example, ionic liquid storage 232 may be branched from a flow of ionic liquid mixture. Most of the ionic liquid mixture may be recirculating, and ionic liquid storage 232 may provide a buffer volume for expansion and contraction of the ionic liquid mixture with temperature and composition, and accommodate any potential surges in flow rate. As another example, in addition to creating a positive pressure differential using pump 238 that generates a pressure on a feed side of filtration unit 260A, pump 274 may generate a vacuum on a permeate side of filtration unit 260A. Such a configuration may reduce a pressure at stripper 208 and/or limit pressure regulation or relief equipment on a retentate side of filtration unit 260A.

In some examples, ionic liquid regeneration systems may remove water from the ionic liquid mixture as part of an ionic liquid circuit between a scrubber and a stripper. FIG. 3A is a schematic diagram illustrating an example contaminant removal system 300A that includes one or more RO/NF membranes within a stripper. Except as indicated below, components of contaminant removal system 300A may be similar to similarly labeled contaminant removal systems 200A and 200B.

In the example of FIG. 3A, system 100 includes an ionic liquid circuit 326, which may operate similarly to ionic liquid circuit 226. However, rather than remove, or in addition to removing, water using a filtration assembly in an ionic liquid circuit, system 300A includes a stripper 308. Stripper 308 is configured to desorb the contaminant from the ionic liquid sorbent into a mixed contaminant stream 360, such as described with respect to stripper 208 in FIGS. 2A and 2B.

In addition to desorbing the contaminant, stripper 308 may also remove liquid water from the ionic liquid mixture. On a liquid phase side, stripper 308 is configured to receive loaded ionic liquid sorbent from scrubber 104 and desorb one or more contaminants from the loaded ionic liquid sorbent. Stripper 308 includes one or more RO/NF membranes 110, each configured to flow the loaded ionic liquid sorbent on one side (e.g., a shell side) of the membrane and contaminants to mixed contaminant stream 360 on an opposite side (e.g., a tube side) of the membrane. Pump 238 and/or pressure regulator 372 may be configured to control a pressure differential and downstream pressure of retentate of RO/NF membranes 110 of stripper 308. Pump 238 may be configured to provide a pressure differential across stripper 308, while a pressure regulator 372 may be configured to reduce a pressure of the ionic liquid mixture downstream of stripper 308.

Contaminants and water may flow across fibers of RO/NF membrane 110 due to a concentration gradient and/or solubility of contaminants in water, while the ionic liquid sorbent may not substantially flow across the fibers of the membrane. On a mixed phase side, stripper 308 is configured to discharge the contaminant and the liquid water in mixed contaminant stream 360. Contaminant stream 360 may continuously remove the contaminant and water from stripper 308 to assist migration of the contaminants and the water from the loaded ionic liquid sorbent into mixed contaminant stream 360.

As a result of this water removal, mixed contaminant stream 360 may include a relatively large amount of water, such as compared to contaminant stream 240 of FIGS. 2A-2C. To separate the water from the contaminant in mixed contaminant stream 360, system 300A includes a degasser 362. Degasser 362 is configured to separate the desorbed contaminant, such as carbon dioxide, from the water, such as through a phase change, a concentration gradient, or any other mechanism of separation. Degasser 362 may receive water and contaminants in mixed contaminant stream 360, remove at least a portion of the contaminants from mixed contaminant stream 360, discharge a contaminant stream 340 to compressor 342, and discharge a removed water stream 366, such as to water storage 116 of FIG. 1A. A variety of degassers may be used for degasser 362 including, but not limited to, membrane degassers, vacuum degassers, static phase separators, capillary phase separator, membrane phase separators, centrifugal/rotary separators, and the like.

In some examples, degasser 362 is a membrane degasser. For example, mixed contaminant stream 360 may enter degasser 362 as a feed gas stream and contact one or more membranes. These membranes may permit the gas phase contaminant and exclude the liquid phase water or other liquid components of mixed contaminant stream 360, such that the contaminant may diffuse through the membrane at a higher rate than the other components of mixed contaminant stream 360. As such, a portion of the contaminants in mixed contaminant stream 360 may permeate through one or more membranes of degasser 362 and discharge from degasser 362 as contaminant stream 340 (permeate stream), while the remainder of mixed contaminant stream 360 may pass through and discharge from degasser 362 as water stream 366 (retentate stream).

In some examples, a heater 371 may supply heat to mixed contaminant stream 360 prior to entry into degasser 362 to aid in desorbing contaminants, such as carbon dioxide, from contaminant stream 360. For example, stripper 308 may operate at a reduced vacuum compared to strippers that do not include RO/NF membranes, such as stripper 208 of FIGS. 2A-2C. Heater 230 may provide a first stage of heating to the ionic liquid mixture to remove contaminants from the ionic liquid mixture. Heater 371 may provide a second stage of heating to mixed contaminant stream 360 to further desorb gaseous contaminants from the liquid water. In some examples, heater 230 may be eliminated.

In some examples, an ionic liquid regeneration system may be further configured to recover ionic liquid from the removed water. FIG. 3B is a schematic diagram illustrating an example contaminant removal system that includes an RO/NF membrane within a stripper in series with an RO/NF membrane unit. In the example of FIG. 3B, system 300B includes a single RO/NF membrane unit 368 in series with stripper 308; however, system 300B may include any number of RO/NF membrane units in series.

As explained above in FIG. 2B, RO/NF membranes 110, such as those included in stripper 308, may not exclude all the ionic liquid sorbent in the ionic liquid mixture, and the permeate stream from stripper 308 may include a small amount of ionic liquid sorbent. To further recover the ionic liquid sorbent, system 300B includes at least two RO/NF membrane units fluidically coupled in series. In the example of FIG. 3B, system 300B includes stripper 308, which includes one or more RO/NF membranes 110, and an RO/NF membrane unit 368 upstream of degasser 362; however, system 300B may include any multiple number of RO/NF membranes in series, including addition RO/NF membrane units.

Stripper 308 is configured to discharge mixed contaminant stream 370 to RO/NF membrane unit 368. Mixed contaminant stream 370 may include a small amount of ionic liquid sorbent. RO/NF membrane unit 368 may be configured to receive mixed contaminant stream 360 as a feed stream, discharge a diluent stream as a return stream 378 that includes the ionic liquid sorbent and a lower volume of water than a permeate stream 370, and discharge permeate stream 370 that includes the removed volume of water. RO/NF membrane unit 368 may discharge return stream 378 to ionic liquid circuit 326, such as downstream of stripper 308. Mixed contaminant stream 370 may include a pump 374 or other pressure source configured to create a pressure differential across RO/NF membrane unit 368 and a pressure regulator 376 configured to maintain a pressure of return stream 378 below a threshold, such as described with respect to pump 238 and pressure regulator 272, respectively. Degasser 362 may be configured to receive permeate stream 370, which includes the contaminant and water, and is substantially free of ionic liquid sorbent, and separate the contaminant from the water for further processing by compressor 342 into a compressed contaminant stream 352.

The techniques described in this disclosure may be implemented, at least in part, in hardware, software, firmware, or any combination thereof. For example, various aspects of the described techniques, such as functionality attributed to controller 118 or the various sensors above, may be implemented within one or more processors, including one or more microprocessors, digital signal processors (DSPs), application specific integrated circuits (ASICs), field programmable gate arrays (FPGAs), or any other equivalent integrated or discrete logic circuitry, as well as any combinations of such components. The term “processor” or “processing circuitry” may generally refer to any of the foregoing logic circuitry, alone or in combination with other logic circuitry, or any other equivalent circuitry. A control unit including hardware may also perform one or more of the techniques of this disclosure.

Such hardware, software, and firmware may be implemented within the same device or within separate devices to support the various techniques described in this disclosure. In addition, any of the described units, modules or components may be implemented together or separately as discrete but interoperable logic devices. Depiction of different features as modules or units is intended to highlight different functional aspects and does not necessarily imply that such modules or units must be realized by separate hardware, firmware, or software components. Rather, functionality associated with one or more modules or units may be performed by separate hardware, firmware, or software components, or integrated within common or separate hardware, firmware, or software components.

The techniques described in this disclosure may also be embodied or encoded in an article of manufacture including a computer-readable storage medium encoded with instructions. Instructions embedded or encoded in an article of manufacture including a computer-readable storage medium, may cause one or more programmable processors, or other processors, to implement one or more of the techniques described herein, such as when instructions included or encoded in the computer-readable storage medium are executed by the one or more processors. Computer readable storage media may include random access memory (RAM), read only memory (ROM), programmable read only memory (PROM), erasable programmable read only memory (EPROM), electronically erasable programmable read only memory (EEPROM), flash memory, a hard disk, a compact disc ROM (CD-ROM), a floppy disk, a cassette, magnetic media, optical media, or other computer readable media. In some examples, an article of manufacture may include one or more computer-readable storage media.

In some examples, a computer-readable storage medium may include a non-transitory medium. The term “non-transitory” may indicate that the storage medium is not embodied in a carrier wave or a propagated signal. In certain examples, a non-transitory storage medium may store data that can, over time, change (e.g., in RAM or cache).

Example 1: A contaminant removal system includes a scrubber configured to absorb a contaminant from an air stream into an ionic liquid sorbent in an ionic liquid mixture; an ionic liquid regeneration assembly configured to: desorb the contaminant from the ionic liquid sorbent; and remove liquid water from the ionic liquid mixture.

Example 2: The contaminant removal system of example 1, wherein the ionic liquid regeneration assembly is configured to remove the liquid water from the ionic liquid mixture using one or more reverse osmosis or nanofiltration (RO/NF) membranes.

Example 3: The contaminant removal system of example 2, wherein the ionic liquid regeneration assembly comprises two or more RO/NF membranes arranged in series and is configured to return at least a portion of ionic liquid sorbent removed with the liquid water to the ionic liquid mixture.

Example 4: The contaminant removal system of example 3, wherein at least one of the two or more RO/NF membranes is configured to return at least a portion of ionic liquid sorbent removed with the liquid water to the ionic liquid mixture.

Example 5: The contaminant removal system of any of examples 2 through 4, wherein the ionic liquid regeneration assembly comprises: a stripper configured to desorb the contaminant from the ionic liquid sorbent; and a filtration assembly is configured to receive the ionic liquid mixture from the scrubber; separate liquid water from the ionic liquid mixture; and discharge the ionic liquid mixture to the stripper.

Example 6: The contaminant removal system of example 5, wherein the filtration assembly comprises at least two RO/NF membranes in series.

Example 7: The contaminant removal system of any of examples 2 through 6, wherein the ionic liquid regeneration assembly comprises: a stripper configured to desorb the contaminant from the ionic liquid sorbent; and remove liquid water from the ionic liquid mixture; and a degasser configured to separate the desorbed contaminant from the liquid water.

Example 8: The contaminant removal system of example 7, wherein the ionic liquid regeneration assembly further comprises at least one of the one or more RO/NF membranes in series with the stripper.

Example 9: The contaminant removal system of any of examples 1 through 8, further comprising a dehumidifier upstream of the scrubber

Example 10: The contaminant removal system of any of examples 1 through 9, wherein the ionic liquid regeneration assembly further comprises a vacuum source configured to generate a vacuum to desorb the contaminant from the ionic liquid sorbent.

Example 11: The contaminant removal system of any of examples 1 through 10, wherein the contaminant is carbon dioxide.

Example 12: The contaminant removal system of example 11, further comprising a Sabatier system configured to generate hydrocarbons using the desorbed contaminant.

Example 13: A method for removing a contaminant from an environment includes absorbing, by a scrubber, a contaminant from an air stream into an ionic liquid sorbent in an ionic liquid mixture; desorbing, by an ionic liquid regeneration assembly, the contaminant from the ionic liquid sorbent; and removing, by the ionic liquid regeneration assembly, liquid water from the ionic liquid mixture.

Example 14: The method of example 13, wherein the ionic liquid regeneration assembly removes the liquid water from the ionic liquid mixture using one or more reverse osmosis or nanofiltration (RO/NF) membranes.

Example 15: The method of example 14, wherein the ionic liquid regeneration assembly comprises two or more RO/NF membranes arranged in series, and wherein the method further comprises returning, by the ionic liquid regeneration assembly, at least a portion of ionic liquid sorbent removed with the liquid water to the ionic liquid mixture.

Example 16: The method of example 15, further comprising returning, by at least one of the two or more RO/NF membranes, at least a portion of ionic liquid sorbent removed with the liquid water to the ionic liquid mixture.

Example 17: The method of any of examples 13 through 16, further comprising generating, by a vacuum source, a vacuum to desorb the contaminant from the ionic liquid sorbent.

Example 18: The method of any of examples 13 through 17, wherein the contaminant is carbon dioxide.

Example 19: The method of example 18, further comprising generating, by a Sabatier system, hydrocarbons using the desorbed contaminant.

Example 20: A method for controlling a contaminant removal system includes controlling, by control circuitry, a heater of an ionic liquid circuit to heat an ionic liquid mixture that includes an ionic liquid sorbent, wherein the ionic liquid circuit comprises: a scrubber configured to absorb a contaminant from an air stream into the ionic liquid sorbent in the ionic liquid mixture; and an ionic liquid regeneration assembly configured to: desorb the contaminant from the ionic liquid sorbent; and remove liquid water from the ionic liquid mixture; controlling, by the control circuitry, a vacuum source of the ionic liquid regeneration assembly to desorb the contaminant from the ionic liquid sorbent using one or more reverse osmosis or nanofiltration (RO/NF) membranes; and controlling, by the control circuitry, a pressure source of the ionic liquid regeneration assembly to generate a pressure differential across the one or more RO/NF membranes.

Various examples have been described. These and other examples are within the scope of the following claims.

What is claimed is:

1. A contaminant removal system, comprising:
a scrubber configured to absorb a contaminant from an air stream into an ionic liquid sorbent in an ionic liquid mixture;
an ionic liquid regeneration assembly configured to:
desorb the contaminant from the ionic liquid sorbent; and
remove liquid water from the ionic liquid mixture.

2. The contaminant removal system of claim 1, wherein the ionic liquid regeneration assembly is configured to remove the liquid water from the ionic liquid mixture using one or more reverse osmosis or nanofiltration (RO/NF) membranes.

3. The contaminant removal system of claim 2, wherein the ionic liquid regeneration assembly comprises two or more RO/NF membranes arranged in series and is configured to return at least a portion of ionic liquid sorbent removed with the liquid water to the ionic liquid mixture.

4. The contaminant removal system of claim 3, wherein at least one of the two or more RO/NF membranes is configured to return at least a portion of ionic liquid sorbent removed with the liquid water to the ionic liquid mixture.

5. The contaminant removal system of claim 2, wherein the ionic liquid regeneration assembly comprises:
a stripper configured to desorb the contaminant from the ionic liquid sorbent; and
a filtration assembly comprising the one or more RO/NF membranes, wherein the filtration assembly is configured to:
receive the ionic liquid mixture from the scrubber;
separate liquid water from the ionic liquid mixture; and
discharge the ionic liquid mixture to the stripper.

6. The contaminant removal system of claim 5, wherein the filtration assembly comprises at least two RO/NF membranes in series.

7. The contaminant removal system of claim 2, wherein the ionic liquid regeneration assembly comprises:
a stripper comprising at least one of the one or more RO/NF membranes, wherein the stripper is configured to:
desorb the contaminant from the ionic liquid sorbent; and
remove liquid water from the ionic liquid mixture; and
a degasser configured to separate the desorbed contaminant from the liquid water.

8. The contaminant removal system of claim 7, wherein the ionic liquid regeneration assembly further comprises at least one of the one or more RO/NF membranes in series with the stripper.

9. The contaminant removal system of claim 1, further comprising a dehumidifier upstream of the scrubber.

10. The contaminant removal system of claim 1, wherein the ionic liquid regeneration assembly further comprises a vacuum source configured to generate a vacuum to desorb the contaminant from the ionic liquid sorbent.

11. The contaminant removal system of claim 1, wherein the contaminant is carbon dioxide.

12. The contaminant removal system of claim 11, further comprising a Sabatier system configured to generate hydrocarbons using the desorbed contaminant.

13. A method for removing a contaminant from an environment, comprising:
absorbing, by a scrubber, a contaminant from an air stream into an ionic liquid sorbent in an ionic liquid mixture;
desorbing, by an ionic liquid regeneration assembly, the contaminant from the ionic liquid sorbent; and
removing, by the ionic liquid regeneration assembly, liquid water from the ionic liquid mixture.

14. The method of claim 13, wherein the ionic liquid regeneration assembly removes the liquid water from the ionic liquid mixture using one or more reverse osmosis or nanofiltration (RO/NF) membranes.

15. The method of claim 14,
wherein the ionic liquid regeneration assembly comprises two or more RO/NF membranes arranged in series, and
wherein the method further comprises returning, by the ionic liquid regeneration assembly, at least a portion of ionic liquid sorbent removed with the liquid water to the ionic liquid mixture.

16. The method of claim 15, further comprising returning, by at least one of the two or more RO/NF membranes, at least a portion of ionic liquid sorbent removed with the liquid water to the ionic liquid mixture.

17. The method of claim 13, further comprising generating, by a vacuum source, a vacuum to desorb the contaminant from the ionic liquid sorbent.

18. The method of claim 13, wherein the contaminant is carbon dioxide.

19. The method of claim 18, further comprising generating, by a Sabatier system, hydrocarbons using the desorbed contaminant.

20. A method for controlling a contaminant removal system, comprising:
controlling, by control circuitry, a heater of an ionic liquid circuit to heat an ionic liquid mixture that includes an ionic liquid sorbent, wherein the ionic liquid circuit comprises:
a scrubber configured to absorb a contaminant from an air stream into the ionic liquid sorbent in the ionic liquid mixture; and
an ionic liquid regeneration assembly configured to:
desorb the contaminant from the ionic liquid sorbent; and
remove liquid water from the ionic liquid mixture using one or more reverse osmosis or nanofiltration (RO/NF) membranes;
controlling, by the control circuitry, a vacuum source of the ionic liquid regeneration assembly to desorb the contaminant from the ionic liquid sorbent; and
controlling, by the control circuitry, a pressure source of the ionic liquid regeneration assembly to generate a pressure differential across the one or more RO/NF membranes.
